(19) United States
(12) Patent Application Publication
(10) Pub. No.: US 2026/0248086 A1
(43) Pub. Date: Aug. 27, 2026

(54) VERTICAL FARMING SYSTEM

(71) Applicant: JONES FOOD COMPANY LIMITED, Scunthorpe Lincolnshire (GB)

(72) Inventors: Glyn STEPHENS, Scunthorpe Lincolnshire (GB); James LLOYD-JONES, Scunthorpe Lincolnshire (GB); Pawel KAROLINCZAK, Scunthorpe Lincolnshire (GB)

(73) Assignee: JONES FOOD COMPANY LIMITED, Scunthorpe Lincolnshire (GB)

(21) Appl. No.: 18/872,634

(22) PCT Filed: Jun. 7, 2023
(86) PCT No.: PCT/EP2023/065278

§ 371 Date: Dec. 6, 2024

(30) Foreign Application Priority Data
Jun. 7, 2022 (GB) 2208361.2

(51) Int. Cl. A01G 31/06

(52) U.S. Cl. CPC A01G 31/06

(57) ABSTRACT

A vertical farming system includes: a plurality of grow trays for receiving a growth medium for germinating, propagating and/or growing living organisms, each grow tray including a bottom tray surface; a plurality of support units, each support unit including a single platform including+ a top platform surface for supporting the bottom tray surface of a grow tray from below, wherein each bottom tray surface and/or each top platform surface are configured such that when a grow tray is supported on top of a support unit, a ventilation space is defined between the bottom tray surface and the top platform surface. Each support unit includes a fan mounted to the platform, the fan being configured to generate an airflow through the ventilation space. A support structure supports the plurality of support units in a vertically spaced arrangement.

### TECHNICAL FIELD

The present invention relates to vertical farming systems.

### BACKGROUND

Historically, systems and methods for growing crops have required large areas of land and have needed to be in located in places with an appropriate climate for the crops to grow effectively.

Indoor vertical farming under artificial lights where grow trays containing crops are vertically arranged on a support structure is gaining popularity for a large number of crops.

The present invention aims to improve the efficiency of setting up a support structure for the grow trays of a vertical farming system and to help control or maintain the environment around the grow trays.

### SUMMARY OF INVENTION

The invention is defined in the accompanying claims.

In a first aspect, the present invention provides a vertical farming system comprising:
a plurality of grow trays for receiving a growth medium for germinating, propagating and/or growing living organisms, each grow tray comprising a bottom tray surface;
a plurality of support units, each support unit comprising a single platform comprising a top platform surface for supporting the bottom tray surface of a grow tray from below, wherein each bottom tray surface and/or each top platform surface are configured such that when a grow tray is supported on top of a support unit, a ventilation space is defined between the bottom tray surface and the top platform surface, each support unit further comprising a fan mounted to the platform, the fan being configured to generate an airflow through the ventilation space; and
a support structure configured to support the plurality of support units in a vertically spaced arrangement.

The platform of each support unit may further comprise a bottom platform surface and a platform opening extending through the top platform surface and the bottom platform surface. The platform opening may be in fluid communication with the ventilation space. The fan may be configured to generate an airflow through the platform opening and ventilation space.

The fan may be mounted at least partially within the platform opening, or directly above or below the platform opening. The fan may be configured to blow air in a vertical direction, e.g. upwards or downwards.

The platform of each support unit may further comprise a plurality of platform openings and a plurality of fans. Each platform opening may have a corresponding fan.

The fan may be a bladeless fan, or the support unit may further comprise a bladeless fan. The bladeless fan may be located below the bottom surface of the platform. The bladeless fan may have an annular nozzle configured to project air in a downwards direction. The annular nozzle may be shaped and sized similarly to the outer perimeter of each grow tray.

Each support unit may further comprise a lighting unit mounted to the platform. The lighting unit may be configured to radiate light to a region below the platform.

The platform may further comprise a vent hole extending through the top platform surface and the bottom platform surface such that the ventilation space is in fluid communication with both the platform opening and the vent hole. The lighting unit may be mounted at least partially within or below the vent hole.

Each support unit may further comprise a plurality of lighting units and a plurality of vent holes. Each lighting unit may be mounted at least partially within or below a corresponding vent hole.

Each support unit may further comprise a heat sink mounted on the lighting unit and configured to dissipate heat from the lighting unit upwards into the vent hole.

The ventilation space may be partially defined by a recessed portion of the top platform surface. The platform opening may extend through the recessed portion and the bottom platform surface.

The ventilation space may alternatively or additionally be partially defined by a recessed portion of the bottom tray surface.

The ventilation space may be in the form of a channel extending between opposing lateral sides of the platform. The bottom tray surface and/or the top platform surface may be configured to define two ventilation spaces in the form of channels arranged either side of a central supporting portion.

Each grow tray may comprise a tray opening for receiving a fluid into the grow tray. An internal surface of the platform may define an internal irrigation conduit for transporting a fluid. The irrigation conduit may comprise an inlet portion for receiving a fluid and an outlet portion couplable to the tray opening to establish fluid communication between the internal irrigation conduit and the grow tray.

The tray opening may extend through the bottom tray surface. The outlet portion may be configured to couple to the tray opening at the bottom tray surface.

The outlet portion may comprise an irrigation connector configured to couple to the tray opening.

The vertical farming system may further comprise a central irrigation system configured to transport a fluid to the inlet portion of the internal irrigation conduit of each support unit.

In a second aspect, the present invention provides a vertical farming system comprising: a plurality of grow trays for receiving a growth medium for germinating, propagating and/or growing living organisms, each grow tray comprising a bottom tray surface;
a plurality of support units, each support unit comprising a single platform comprising a top platform surface for supporting the bottom tray surface of a grow tray from below, wherein an internal surface of the platform defines an internal irrigation conduit comprising an inlet portion for receiving a fluid and an outlet portion for delivering the fluid to a grow tray supported on the platform; and
a support structure configured to support the plurality of support units in a vertically spaced arrangement.

Each grow tray may comprise a tray opening for receiving a fluid into the grow tray. The outlet portion of the internal irrigation conduit may be couplable to the tray opening to establish fluid communication between the internal irrigation conduit and the grow tray.

The tray opening may extend through the bottom tray surface.

The outlet portion may comprise an irrigation connector configured to couple to the tray opening at the bottom tray surface.

The vertical farming system may further comprise a central irrigation system configured to transport a fluid to the inlet portion of the internal irrigation conduit of each support unit.

Each support unit may further comprise a lighting unit mounted to the platform. The lighting unit may be configured to radiate light to a region below the platform.

In a third aspect, the present invention provides a vertical farming system comprising:
a plurality of grow trays for receiving a growth medium for germinating, propagating and/or growing living organisms;
a support structure configured to support the plurality of grow trays in a plurality of vertically spaced tray positions; and
a plurality of bladeless fans, each bladeless fan located above one or more corresponding tray positions, each bladeless fan comprising an annular nozzle configured to project air in a downwards direction.

Each annular nozzle may be sized and shaped similarly to the outer perimeter of at least one of the grow trays.

The vertical farming system may further comprise one or more lighting units located above each tray position. The one or more lighting units may be configured to radiate light downwards to their associated tray position. The annular nozzle of each bladeless fan may extend around the one or more lighting units at each tray position.

The bladeless fan may comprise a base housing a motor-driven impeller for drawing air into the base. The annular nozzle may be connected to the base such that the drawn air is driven by the impeller into an interior annular passage of the annular nozzle. The annular nozzle may further comprise an annular outlet through which the air is projected. The annular nozzle 152 may further comprise a Coanda surface located adjacent to the annular outlet over which the air is directed as it leaves the annular outlet.

In any of the above aspects, the platform of at least one support unit may further comprise a power supply connector configured to electrically couple to an external power supply to transfer power from the external power supply to at least one electrical or electronic component of the support unit.

The platform of each support unit may comprise a power transfer connector configured to allow adjacent support units to be electrically coupled to transfer power between adjacent support units.

The platform of each support unit may comprise an internal rechargeable or replaceable power source configured to supply power to at least one electrical or electronic component of the support unit.

Each support unit may further comprise at least one sensor mounted to the platform. The at least one sensor may be configured to measure at least one of: temperature, humidity, light intensity and CO2 concentration.

Each support unit may further comprise wireless communication means configured to transmit data from the at least one sensor to an external data logging device.

### BRIEF DESCRIPTION OF THE DRAWINGS

The present invention will now be described, by way of example only, with reference to the accompanying drawings, in which:

FIG. 1 is a perspective view of a support structure supporting a plurality of support units in a vertically spaced arrangement.

FIG. 2 shows the support structure of FIG. 1 with grow trays placed on top of each support unit

FIG. 3 shows the support structure of FIG. 1 expanded in X and Y horizontal directions.

FIG. 4 is a top perspective view of a support unit.

FIG. 5 shows the support unit of FIG. 4 with a grow tray placed on top.

FIG. 6 is a bottom perspective view of the support unit of FIG. 4.

FIG. 7 is a cross-sectional perspective view of the support unit of FIG. 4 along a line extending transversely through strip lighting units mounted on the support unit.

FIG. 8 is a perspective view of an example arrangement of support units comprising bladeless fans.

FIG. 9 is a cross-sectional perspective view of a support unit from FIG. 8.

FIG. 10 is a perspective view of two adjacent support units that are electrically coupled together.

FIG. 11 is a cross-sectional side view of the support unit and grow tray of FIG. 4 along a line extending along an internal irrigation conduit of the support unit.

FIG. 12 is a perspective view of two support units connected to a central fluid supply conduit.

### DETAILED DESCRIPTION

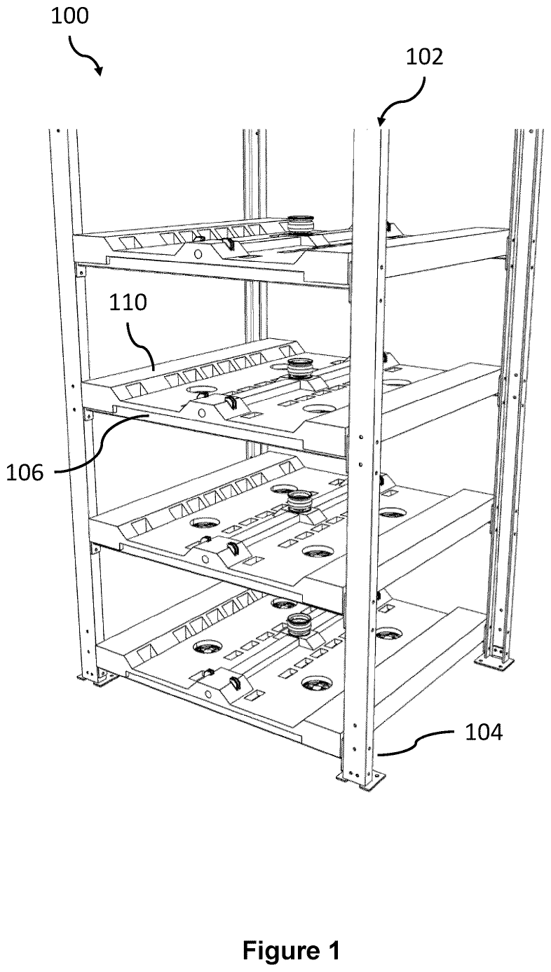

FIG. 1 shows a portion of a vertical farming system 100. The vertical farming system 100 comprises a support structure 102 for supporting a plurality of support units 110 in a vertically spaced arrangement. The illustrated portion of the support structure 102 comprises four upright members 104 defining a rectangular column with the upright members 104 located at the corners, and a plurality of vertically spaced horizontal members 106 connecting the two upright members 104 at the front of the figure and the two upright members 104 at the rear of the figure to form pairs of horizontal members 106, each pair defining a level of the support structure 102. Each support unit 110 rests on a pair of horizontal members 106.

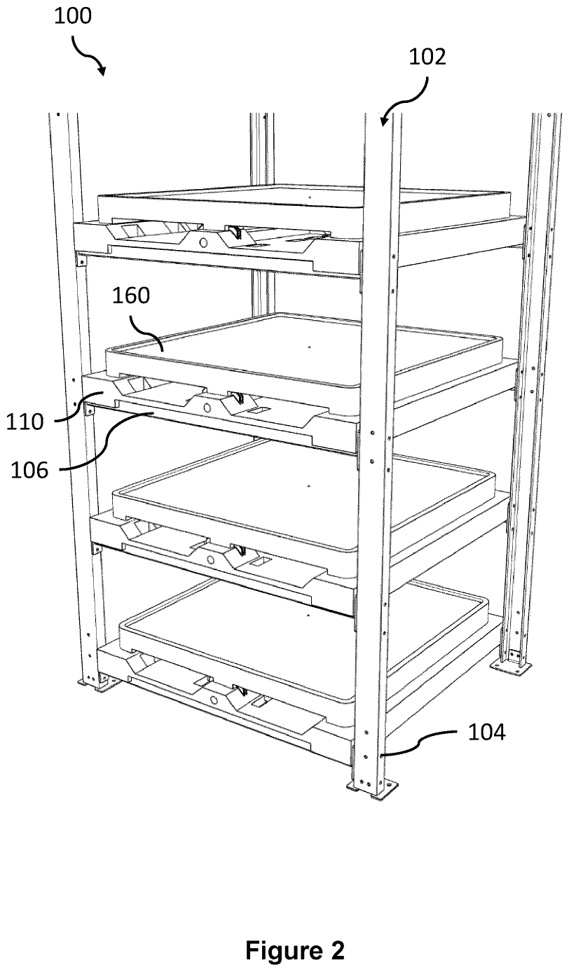

As shown in FIG. 2, the vertical farming system 100 further comprises a plurality of grow trays 160 which can be placed directly on top of a support unit 110 such that each support unit 110 supports a grow tray 160 from below. Each grow tray 160 may be made from plastic (e.g. a thermoplastic such as HDPE or nylon) and may be formed by known plastic moulding processes, e.g. injection moulding. In use, the grow tray 160 can contain a growing medium on which crops can be grown from seed. The grow tray 160 may be used for hydroponic crop growth. Typical growing media for hydroponic growth include mineral wool (e.g. ROCKWOOL™), perlite, vermiculite, coir, clay pellets, etc. The growing media may be in the form of a sheet, e.g. a mineral wool sheet.

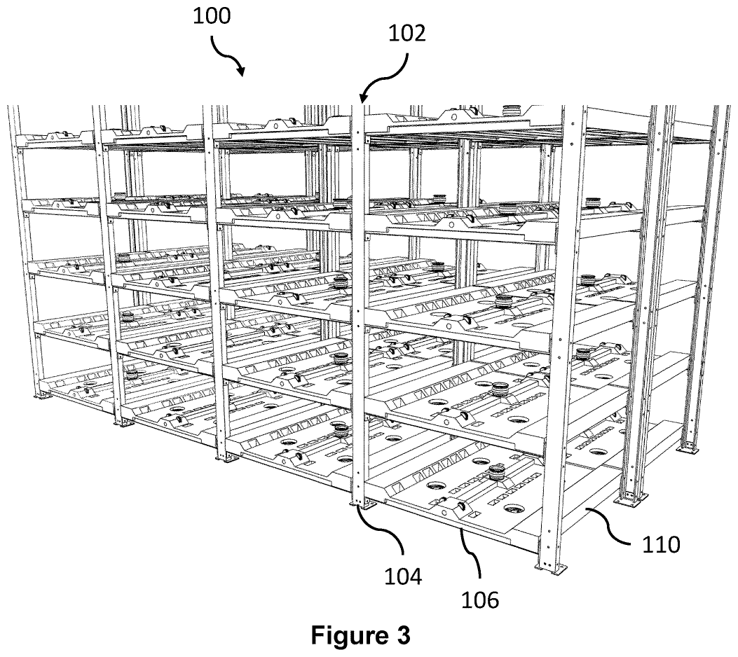

As shown in FIG. 3, the portion of the support structure 102 shown in FIG. 1 is modular in that it can be extended in orthogonal horizontal directions by adding more upright members 104 and horizontal members 106. The support structure 102 can also be extended in the vertical direction by using taller upright members 104 or joining a plurality of upright members 104 together in the vertical direction, together with more pairs of horizontal members 106 to create more levels for supporting more support units 110.

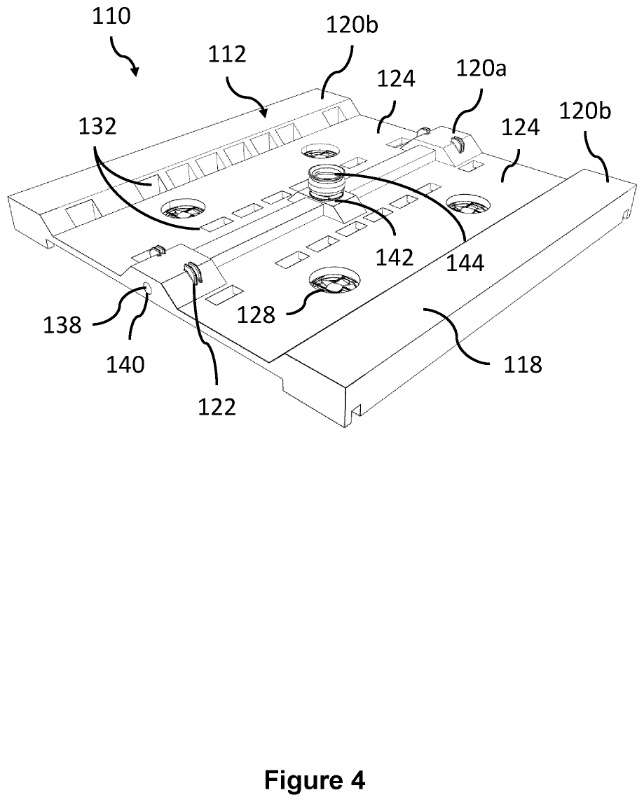

FIG. 4 shows a top perspective view of a support unit 110. The support unit 110 comprises a single platform 112. The platform 112 may, for example, be made from plastic (e.g. a thermoplastic such as HDPE or nylon) and may be formed by known plastic moulding processes, e.g. injection moulding. The platform 112 may be formed as a single piece (i.e. have a unitary construction).

The platform 112 comprises a top platform surface 118 for supporting a grow tray 160 from below and a bottom platform surface 114. In this particular example, the top platform surface 118 comprises a central supporting portion 120a running between two opposing lateral sides of the platform 112 and two edge supporting portions 120b running parallel on either side of the central supporting portion 120a, at respective edges of the platform 112. Between each edge supporting portion 120b and the central supporting portion 120a, the top platform surface 118 comprises two recessed portions 124 on either side of the central supporting portion 120a. The recessed portions 124 are recessed relative to the supporting portions 120a, 120b of the top platform surface and also extend between the two opposing lateral sides of the platform 112 to form two channels.

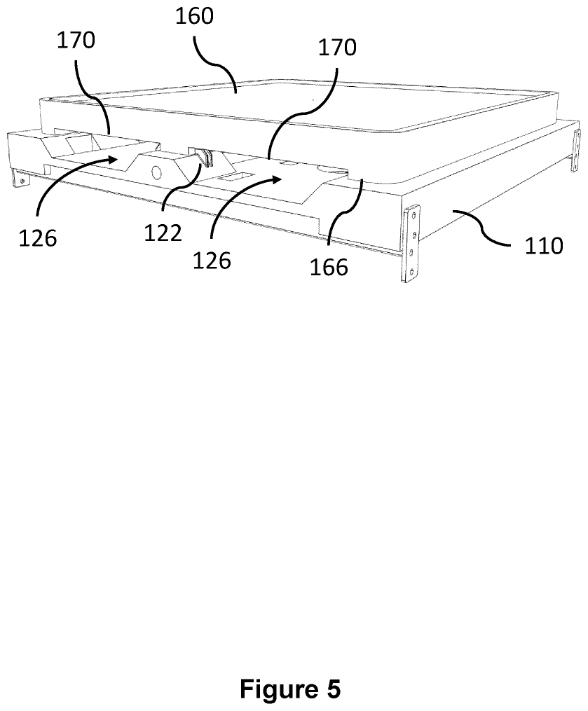

FIG. 5 shows a grow tray 160 on top of the support unit 110. The central and edge supporting portions 120a, 120b provide a substantially horizontal planar surface on top of which the grow tray 160 can rest. Furthermore, once a grow tray 160 is placed on top of the support unit 110 such that the bottom tray surface 166 is in contact with the supporting portions 120a, 120b of the top platform surface 118, a ventilation space 126 is defined between each recessed portion 124 of the top platform surface 118 and the bottom tray surface 166 of the grow tray 160. In this particular example, the bottom tray surface 166 also comprises recessed portions 170 such that the ventilation spaces 126 are defined between the recessed portions of the top platform surface 118 and the bottom tray surface 166.

The central supporting portion 120a also comprises aligning features 122 that engage corresponding aligning features on the bottom of the grow tray 160 to help align the grow tray 160 into a particular position on the support unit 110. In this particular example, the aligning features 122 are in the form of upwardly protruding ribs that interdigitate with corresponding downwardly protruding ribs on the grow tray 160, but the aligning features 122 of the support unit 110 and the corresponding aligning features of the grow tray 160 could take the form of any suitable protrusion and corresponding recess or vice versa.

Referring back to FIG. 4 the support unit 110 further comprises four platform openings 128 in the form of through-holes extending through the recessed portions 124 of the top platform surface 118 and the bottom platform surface 114. The support unit 110 further comprises four vent holes 132 in the form of through-holes extending through the recessed portions 124 of the top platform surface 118 and the bottom platform surface 114.

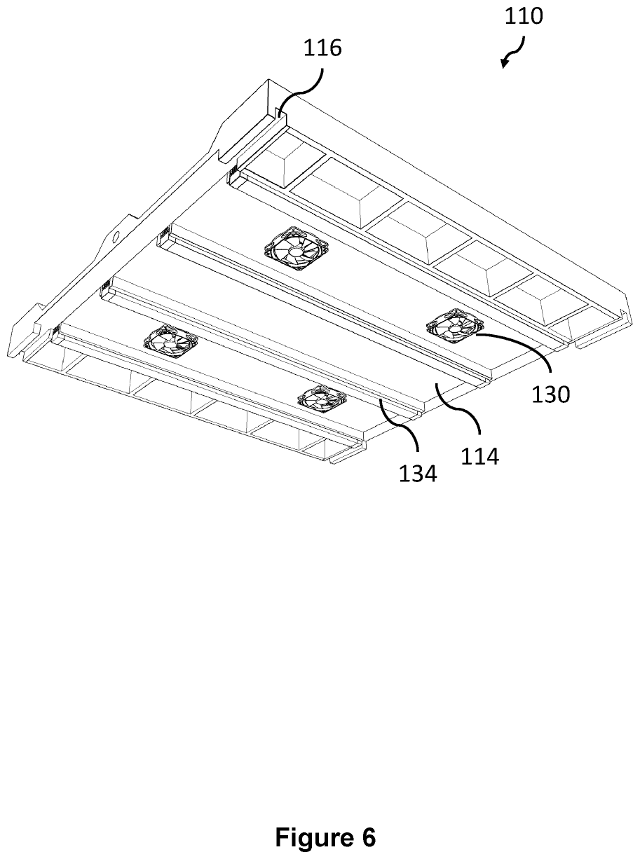

FIG. 6 is a bottom perspective view of the support unit 110. The bottom platform surface 114 comprises a pair of grooves 116 at opposing ends of the platform 112 which receive a pair horizontal members 106 of the support structure 102 when the support unit 110 is placed on the support structure 110.

The support unit 110 further comprises four fans 130 mounted on the bottom platform surface 114 directly below a corresponding platform opening 128 so that the fans 130 cover the platform openings 128. The fans are configured to blow air in a vertical direction, either upwards or downwards. Instead of being mounted directly below the platform openings 128, the fans 130 could also be mounted at least partially within the platform openings 128, or directly above the platform openings 128, if the ventilation spaces 126 are large enough.

The support unit 110 further comprises four lighting units 134 in the form of strip lights which are mounted at least partially within or directly below a corresponding vent hole 132. The lighting units 134 face downwards such that in use, they radiate artificial light to a region below the platform 112 (i.e. the lighting units of a particular support unit 110 on the support structure 102 radiate light to the grow tray directly below that particular support unit 110). The lighting units 134 may be LED strip lights configured to radiate light with a spectrum that promotes growth of a crop being grown in the grow trays 160.

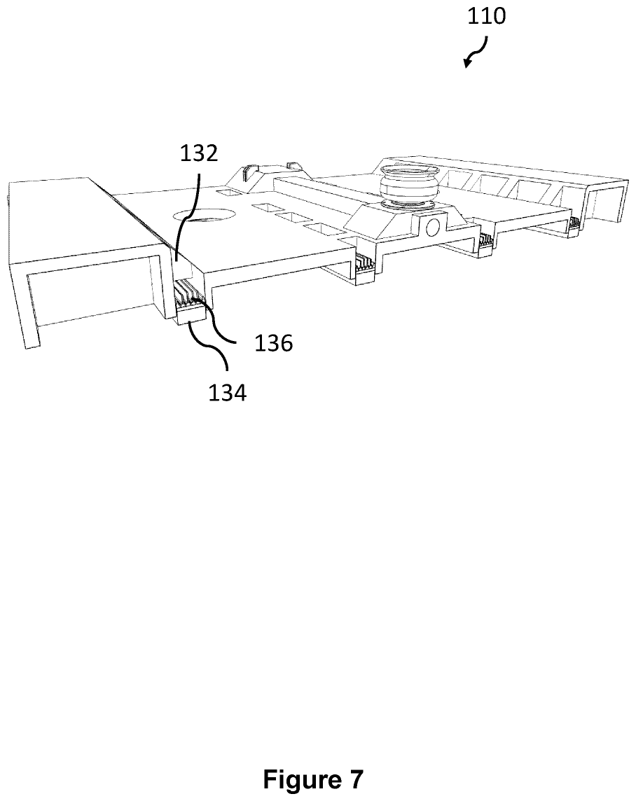

FIG. 7 shows a cross-sectional perspective view of the support unit 110 along a line extending transversely through the lighting units 134 showing the lighting units 134 situated within the vent holes 132. Within each vent hole 132, there is a heat sink 134 mounted on top of each lighting unit 134. The heat sinks 136 have a strip shape similar to the light units 134. The heat sinks 134 may be provided as part of the platform 112 such that the lighting units 134 are installed onto the platform by mounting the lighting units onto the bottom of the heat sinks 134, or the heat sinks 134 may be provided as part of the lighting units 134 such that the lighting units 134 already comprise a heat sink 134 before the lighting units 134 are mounted to the platform 112. In use, the heat sinks 136 transfer heat generated by the lighting units 134 to the air within and above the vent holes 132. The heat sinks 136 comprise fins to increase the surface area available for heat transfer and the heat sinks 136 may be made from any material suitable for acting as a heat sink, e.g. a material with a high heat capacity and thermal conductivity, such as aluminium or copper.

As shown in FIG. 7, the vent holes 132 are in the form of continuous channels towards the bottom platform surface 114 to accommodate the strip lighting units 134, but are in the form of a series of sub-vent holes towards the top platform surface 118. This configuration of the vent holes 132 may be useful to maintain the structural integrity of the platform 112.

Given that the platform openings 128 and the vent holes 132 extend through the recessed portions 124 of the top platform surface 118, each ventilation space 126 is also in fluid communication with corresponding platform openings 128 and vent holes 132. Each ventilation space 126 is also open at the opposing lateral sides of the platform 112.

In use, the fans 130 operate to generate an airflow in the vicinity of each grow tray 160 at each level of the support structure. These airflows helps to evenly distribute heat, humidity, CO2, etc., which helps to provide uniform conditions for optimal and uniform crop growth. The fans 130 also operate to generate an airflow through each ventilation space 126, which helps to remove warm air generated by the lighting units 134 away from the bottom of the grow trays 160. The fans 130 also help to introduce air from a controlled environment surrounding the support structure into the middle of the support structure 100 so that the growing environment across all grow trays 160 matches the controlled environment as much and as quickly as possible.

The fans 130 may be configured to blow upwards or blow downwards, as both directions have the same effect of generating an airflow through each ventilation space 126. However, it may be more desirable to configure the fans 130 to blow air upwards to avoid air pushing down on the crops in the grow trays 160.

In addition to the ventilation spaces 126 providing paths for air to circulate within the support structure 100, the two ventilation spaces 126 of this example also allow the forks of a forklift vehicle to be inserted or retracted underneath a grow tray 160 supported on a support unit 110 so that the grow tray 160 can be picked up off or placed onto the support unit 110. While in this example the top platform surface 118 and the bottom tray surface 166 both comprise recessed portions 124, 166 between which the ventilation spaces 126 are defined, only one of top platform surface 118 and the bottom tray surface 166 could be provided with recessed portions, with the other surface being substantially planar. However, allowing a forklift vehicle to handle the grow trays 160 is not essential and therefore any number and arrangement of ventilations spaces 126 may be defined between the support unit 110 and the grow tray 160. The support unit is also not limited to the precise number of platform openings 128, fans 130, vent holes 132, lighting units 134 and heat sinks 136 described in the above example. One or more of each of these features may be provided, depending on the ventilation and lighting needs of the vertical farming system 100.

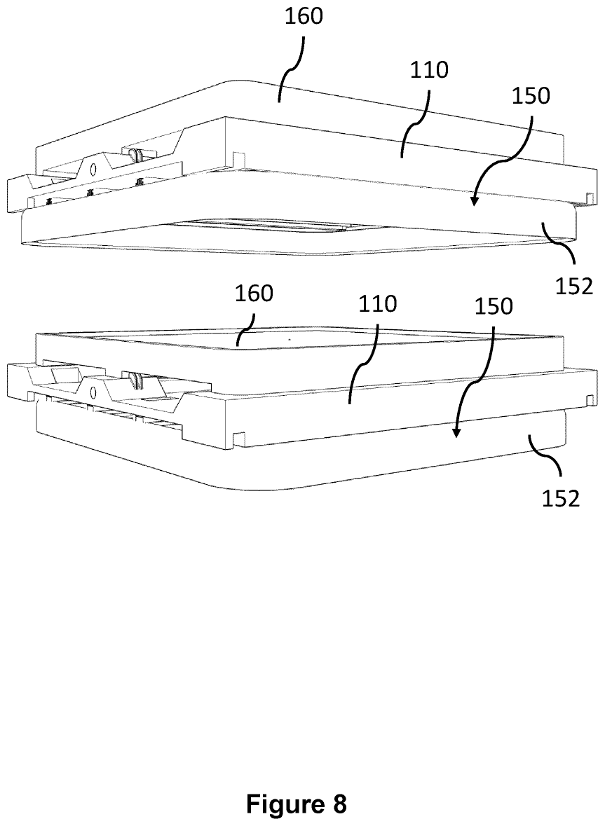

FIG. 8 shows an alternative example in which instead of, or in addition to, the individual fans 130 provided for each platform opening 128, the support unit 110 comprises a “bladeless” fan 150 mounted on the bottom side of the platform 112 of each support unit 110. The bladeless fan 150 comprises an annular nozzle 152 configured to project air in a downwards direction towards a grow tray 160 directly below the annular nozzle on the support structure 102. Furthermore, the annular nozzle 152 is shaped and sized similarly to the outer perimeter of the grow trays 160 such that the air is projected substantially around the edge of the grow tray 160.

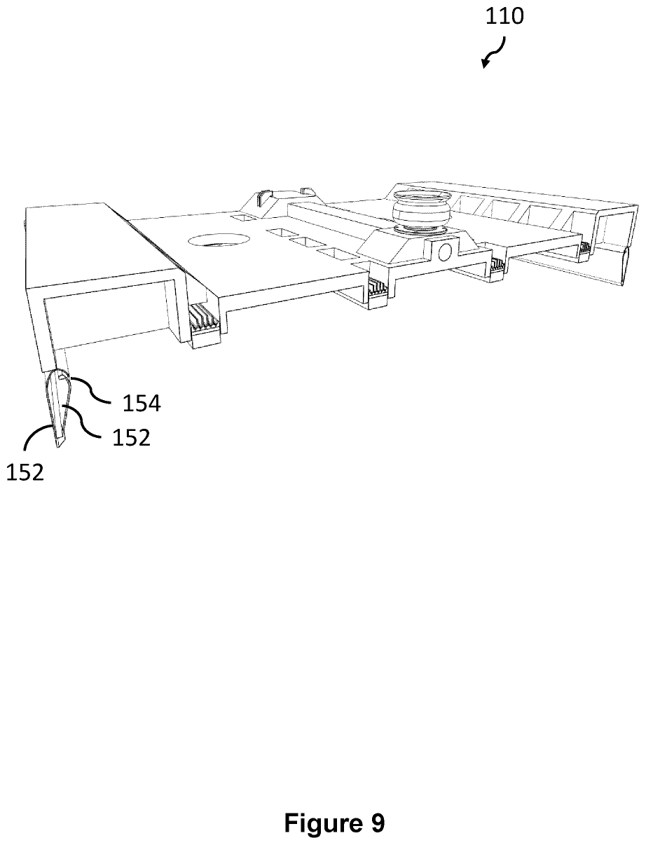

The principle of how a bladeless fan operates is well known. For example, WO2010/100451 (Dyson Technology Limited), hereby incorporated by reference, describes the structure and operation of a bladeless fan. For example, to generate the airflow projected by the annular nozzle 152, the bladeless fan 150 of the present support unit 110 may comprise a base (not shown) housing a motor-driven impeller for drawing air into the base. Referring to the cross-sectional perspective view of the support unit 110 in FIG. 9, the annular nozzle 152 is connected to the base (not shown) such that the drawn air is driven by the impeller into an interior annular passage 154 of the annular nozzle 152. The annular nozzle 152 further comprises an annular outlet 156 in the form of an annular slot through which the air is projected. As the air is projected downwards, air from the ventilation spaces 126 is drawn downwards through the platform openings 128 and through the central opening defined by the annular nozzle 152 to create an airflow flowing through each ventilation space 126 in a downwards direction towards the grow tray 160. The annular nozzle 152 may further comprise a Coanda surface located adjacent to the annular outlet 156 over which the air is directed as it leaves the annular outlet 156. In this way, an increased amount of air can be drawn downwards through the ventilation spaces 126.

The use of a bladeless fan 150 as described can generate smooth, uniform airflow substantially covering the grow tray 160 all the way to the outer perimeter, which can help to provide a more uniform growing environment across each grow tray 160. Furthermore, the annular shape of the annular nozzle 152 does not interfere with the light radiated by the lighting units 134 because the annular nozzle can extend around the outside of the lighting units 134. In addition, the bladeless fan 150 can be used to replace the individual fans 130, which would allow the number of electrical components on each support unit 110 to be reduce while still providing good airflow over a large surface area.

To provide electrical power to each support unit 110 to power the fans 130, 150 and/or the lighting units 134, each support unit 110 may comprise a power supply connector (not shown) configured to connect to an external power supply (not shown). Wires for transferring power from the external power supply to the support units 110 may be routed up the upright members 104. Wires for transferring power between the power supply connector and the fans 130, 150, the lighting units 134, and/or any other electrical components may be routed via grooves (not shown) in the top and/or bottom platform surfaces 114, 118, or the wires may be routed internally within the platform 112. The platform 112 may comprise connection interfaces for reversibly connecting the fans 130, 150, the lighting units 134 and/or other electrical components to the power supply connector so that the fans and lighting units can be electrically coupled and mounted to the platform 112 quickly and easily.

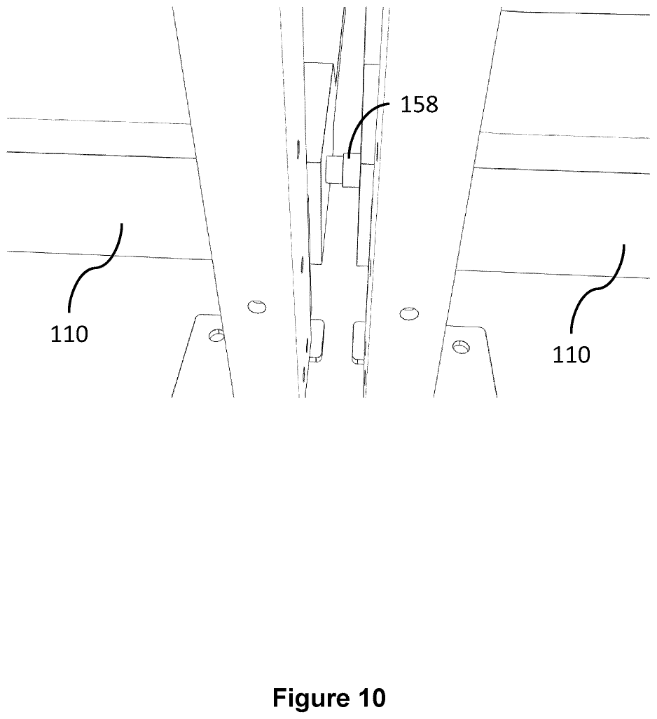

Other ways of providing power to the electrical components on the platform are also possible. For example, as shown in FIG. 10, horizontally adjacent support units 110 may be electrically coupled together via electrical connectors 158. In this way, only one support unit 110 within a chain of electrically coupled support units 110 needs to be connected to an external power supply.

Alternatively the platform 112 may comprise an internal rechargeable or replaceable power source (e.g. a battery) and connection interfaces for reversibly connecting the fans 130, 150, the lighting units 134 and/or other electrical components to the internal power source. Alternatively, each electrical component may have its own integrated power source.

Referring back to FIG. 4, the support unit 110 further comprises an internal irrigation conduit 138 defined by an internal surface of the platform 112. In this particular example, the internal irrigation conduit 138 is defined by an internal surface below the central supporting portion 120a of the top platform surface 118. The internal irrigation conduit 138 extends from one lateral side of the platform 112 to an opposing lateral side of the platform 112, with two inlet portions 140 at either end of the internal irrigation conduit 138 for receiving fluid into the internal irrigation conduit 138 and an outlet portion 142 at the centre. The outlet portion 142 is configured to deliver fluid from the internal irrigation conduit 138 to the top platform surface 118. The outlet portion 142 comprises an irrigation connector 144 for connecting to a grow tray 160 supported on the support unit 110. The irrigation connector 144 is configured to be removably insertable into the internal irrigation conduit via the outlet portion 142.

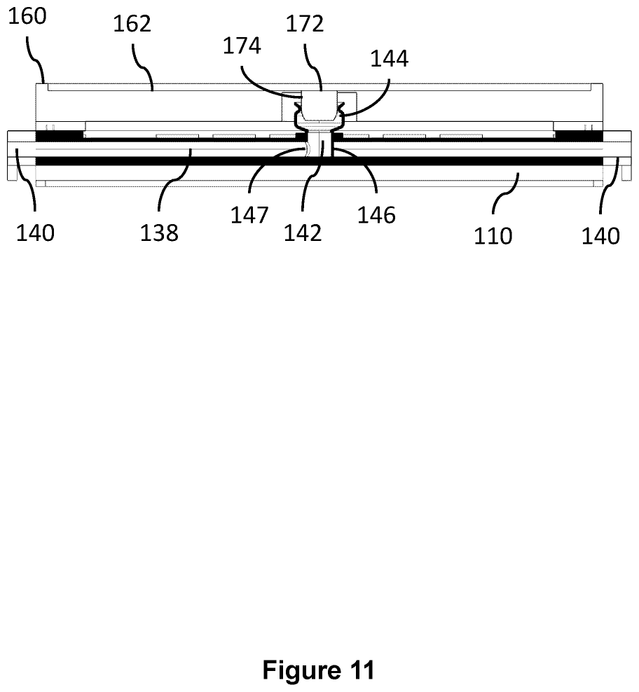

FIG. 11 shows a cross-sectional side view of the support unit 110 respectively along a line extending along the internal irrigation conduit 138. The irrigation connector 144 comprises a vertically extending tubular wall 146 defining a side opening 147. The irrigation connector 144 can be inserted into the outlet portion 142 such that the side opening 147 aligns with one side of the internal irrigation conduit 138 but the tubular wall 146 blocks the other half of the internal irrigation conduit 138. In this way, fluid flowing into the internal irrigation conduit 138 from the inlet portion 140 on the open side can pass through the outlet portion 142 via the irrigation connector, but the fluid is blocked from flowing out the other inlet portion 140 on the blocked side of the internal irrigation conduit 138.

The grow tray 160 is configured to receive fluid into the grow tray 160 from below via an irrigation opening 172 extending through the base 162 of the grow tray 160 (the irrigation opening 172 is shown in FIG. 11 but not any of the other figures, even though it is present). The bottom tray surface 166 of the grow tray 160 comprises a protruding male connecting portion 174 encircling the irrigation opening 172 and the irrigation connector 144 of the support unit 110 is a female connector configured to receive the male connecting portion 174 in a downwards direction. When the grow tray 160 is received on the support unit 110, the male connecting portion is received in the irrigation connector 144 such that the irrigation opening 172 of the grow tray 160 is in fluid communication with internal irrigation conduit 138.

The irrigation connector 144 can be made from a flexible material, e.g. a rubber material, such that a water-tight seal can be formed between the irrigation connector 144 and the male connecting portion 174.

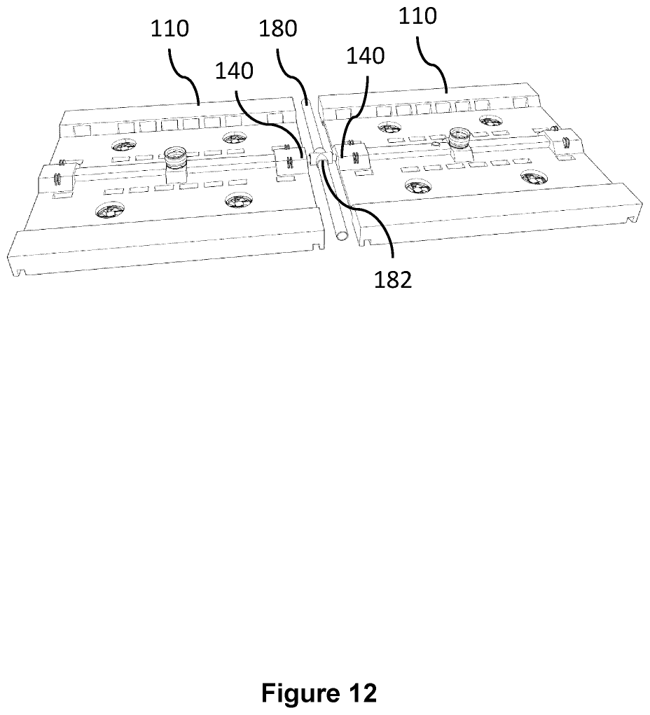

FIG. 12 shows how a fluid can be delivered to the internal irrigation conduit 138 of each grow tray 160. The vertical farming system 100 comprises an irrigation system configured to transport fluid from a central fluid source to the internal irrigation conduit 138 of each support unit 110. The irrigation system comprises a plurality of supply conduits 180 extending horizontally at each level of the support structure 102. Pairs of opposing support units 110 on a particular level are arranged along both sides of the supply conduit 180 on that level and the supply units 110 are orientated such that one of the inlet portions 140 faces the supply conduit 180. The irrigation system further comprises four-way connectors 182 spaced along the supply conduit 180 configured to connect the supply conduit 180 to one of the inlet portions 140 of the supporting units 110 in each pair. Each of the supply conduits 180 on each level may be connected to a central supply conduit for supplying a fluid to each of the supply conduits 180.

To fill the grow trays 160 with fluid, fluid is supplied to the supply conduits 180, which causes fluid to flow into the grow trays via the internal irrigation conduits 138 of the support units 110. Once the fluid level in each grow tray 160 reaches a desired level, the fluid can be held in the grow trays 160 for a predetermined period of time before allowing the fluid in the grow trays 160 to drain out under gravity via the internal irrigation conduits 138 and the supply conduits 180. The supply conduits 180 may be connected to a central drain conduit that transports drained fluid away from the support structure 102. The irrigation system may comprise one or more valves for controlling the supply and draining of fluid to and from the grow trays 160.

The irrigation system is not limited to the above-described arrangement and other arrangements of conduits are possible for supplying fluid to each of the grow trays. For example, instead of horizontally extending supply conduits at each level, the irrigation system may comprise vertically extending supply conduits configured to supply fluid to grow trays 160 at different levels.

Furthermore, although having two inlet portions 140 for the internal irrigation conduit 138 provides flexibility as to how each support unit 110 is orientated on the support structure, the internal irrigation conduit 138 could of course only be formed with one inlet portion 140 (e.g. the internal irrigation conduit 138 does not extend past the outlet portion 142 to the other side of the platform 112. This

The fluid used in the vertical farming system 100 may be a liquid or liquid solution, e.g. water with dissolved nutrients or other substances for promoting crop growth.

The support unit 110 may also further comprise one or more sensors (not shown) mounted on the platform 112. The sensors may be configured to monitor one or more local environmental conditions such as temperature, humidity, light intensity, CO₂ concentration, etc. The support unit 110 may further comprising data communication means for transmitting data from the sensors to an external data logging device so that the environment throughout the support structure 102 can be monitored. The data communication means may be wired (e.g. with wires routed along the upright members 104), or wireless, using any suitable wireless network protocol, e.g. Bluetooth™, Wi-Fi™, LoRaWAN™, etc.

The support unit 110 of the present vertical farming system 100 therefore provides a support for a grow tray 160 which conveniently integrates one or more utilities, such as ventilation, light, irrigation and/or power into a single platform 114. The use of a single platform 114 with integrated utilities allows the vertical farming system 100 to be assembled quickly, in a modular fashion, and allows grow trays 160 to be simply placed on the platform 114 without any further manual connections.

The invention is not limited to the precise forms described above and various modifications and variations will be apparent to the skilled person without departing from the scope of the invention as defined in the accompanying claims. For example, although the support unit 110 described above has a plurality of integrated utilities, a support unit 110 having only one integrated utility may still be beneficial. Furthermore, although the support unit 110 described above is configured to support only one grow tray 160, the support unit 110 may be sized to support a plurality of grow trays 160 on a single platform 112. In this case, the internal irrigation conduit 138 may comprise a plurality of outlet portions 142 for coupling to a plurality of grow trays 160. Furthermore, the support units 110 do not necessarily need to supported on the horizontal members 104 of the support structure 102 and instead could be directly mounted to the upright members 102.

Although the bladeless fan 150 example has been described above in combination with a support unit 110, a bladeless fan 150 may be used more generally in vertical farming systems to provide airflow over a larger area using fewer electrical components compared to using lots of conventional bladed fans. For example, a vertical farming system may comprise a plurality of grow trays and a support structure for supporting the plurality of grow trays in a plurality of vertically spaced tray positions (e.g. using a shelf, a rack, or other supporting means). A bladeless fan may be provided above one or more corresponding tray position, with each bladeless fan comprising an annular nozzle configured to project air in a downwards direction. The annular nozzle may be shaped and sized similarly to the outer perimeter of at least one of the grow trays. For example, the annular nozzle may be shaped and sized similarly to the outer perimeter of one grow tray so that the bladeless fan generates airflow around one grow tray. However, the annular nozzle could be sized larger so that it extends around two or more grow trays. The vertical farming system may further comprise one or more lighting units located above each tray position for radiating light downwards onto each grow tray. The annular nozzle may be configured to extend around the lighting units at each tray position so that the radiated light is not blocked by the bladeless fan.

1-29. (canceled)

30. A vertical farming system comprising:
a plurality of grow trays for receiving a growth medium for germinating, propagating and/or growing living organisms, each grow tray including a bottom tray surface;
a plurality of support units, each support unit including a single platform including a top platform surface for supporting the bottom tray surface of a grow tray from below, wherein each bottom tray surface and/or each top platform surface are configured such that when a grow tray is supported on top of a support unit, a ventilation space is defined between the bottom tray surface and the top platform surface, each support unit including a fan mounted to the platform, the fan being configured to generate an airflow through the ventilation space; and
a support structure configured to support the plurality of support units in a vertically spaced arrangement.

31. The vertical farming system of claim 30, wherein the platform of each support unit comprises:
a bottom platform surface and a platform opening extending through the top platform surface and the bottom platform surface; and
wherein the platform opening is in fluid communication with the ventilation space and the fan is configured to generate an airflow through the platform opening and ventilation space.

32. The vertical farming system of claim 31, wherein the fan is mounted at least partially within the platform opening, or directly above or below the platform opening, and the fan is configured to blow air in a vertical direction.

33. The vertical farming system of claim 30, wherein the fan is a bladeless fan, and/or the support unit comprises:
a bladeless fan, located below the bottom surface of the platform, the bladeless fan having an annular nozzle configured to project air in a downwards direction; and
wherein the annular nozzle is shaped and sized similarly to the outer perimeter of each grow tray.

34. The vertical farming system of claim 30, wherein each support unit comprises:
a lighting unit mounted to the platform, the lighting unit being configured to radiate light to a region below the platform.

35. The vertical farming system of claim 34, wherein the platform comprises:
a vent hole extending through the top platform surface and the bottom platform surface such that the ventilation space is in fluid communication with both the platform opening and the vent hole; and the lighting unit is mounted at least partially within or below the vent hole.

36. The vertical farming system of claim 35, wherein the support unit comprises:
a heat sink mounted on the lighting unit and configured to dissipate heat from the lighting unit upwards into the vent hole.

37. The vertical farming system of claim 30, wherein the ventilation space is partially defined by a recessed portion of the top platform surface; and
the platform opening extends through the recessed portion and the bottom platform surface.

38. The vertical farming system of claim 30, wherein the ventilation space is partially defined by a recessed portion of the bottom tray surface.

39. The vertical farming system of claim 30, wherein the ventilation space is formed as a channel extending between opposing lateral sides of the platform.

40. The vertical farming system of claim 39, wherein the bottom tray surface and/or the top platform surface are configured to define two ventilation spaces formed as channels arranged on either side of a central supporting portion.

41. The vertical farming system of claim 30, wherein each grow tray comprises:
a tray opening for receiving a fluid into the grow tray; and
wherein an internal surface of the platform defines an internal irrigation conduit for transporting a fluid, the irrigation conduit including an inlet portion for receiving a fluid, and an outlet portion configured to be couplable to the tray opening to establish fluid communication between the internal irrigation conduit and the grow tray.

42. The vertical farming system of claim 41, wherein the tray opening extends through the bottom tray surface and the outlet portion is configured to couple to the tray opening at the bottom tray surface.

43. The vertical farming system of claim 42, wherein the outlet portion comprises:
an irrigation connector configured to couple to the tray opening.

44. The vertical farming system of claim 41, comprising:
a central irrigation system configured to transport a fluid to the inlet portion of the internal irrigation conduit of each support unit.

45. A vertical farming system comprising:
a plurality of grow trays for receiving a growth medium for germinating, propagating and/or growing living organisms, each grow tray including a bottom tray surface;
a plurality of support units, each support unit including a single platform including a top platform surface for supporting the bottom tray surface of a grow tray from below, wherein an internal surface of the platform defines an internal irrigation conduit including an inlet portion for receiving a fluid, and an outlet portion for delivering the fluid to a grow tray supported on the platform; and
a support structure configured to support the plurality of support units in a vertically spaced arrangement.

46. The vertical farming system of claim 45, wherein each grow tray comprises:
a tray opening for receiving a fluid into the grow tray, and the outlet portion of the internal irrigation conduit is configured to be couplable to the tray opening to establish fluid communication between the internal irrigation conduit and the grow tray; and
optionally wherein the tray opening extends through the bottom tray surface.

47. The vertical farming system of claim 45, comprising:
a central irrigation system configured to transport a fluid to the inlet portion of the internal irrigation conduit of each support unit.

48. A vertical farming system comprising:
a plurality of grow trays for receiving a growth medium for germinating, propagating and/or growing living organisms;
a support structure configured to support the plurality of grow trays in a plurality of vertically spaced tray positions; and
a plurality of bladeless fans, each bladeless fan being located above one or more corresponding tray positions, each bladeless fan including an annular nozzle configured to project air in a downwards direction.

49. The vertical farming system of claim 48, wherein each annular nozzle is sized and shaped similarly to the outer perimeter of at least one of the grow trays.
